(19) United States
(12) Patent Application Publication
(10) Pub. No.: US 2019/0095410 A1
(43) Pub. Date: Mar. 28, 2019

(54) SYSTEM AND METHOD FOR DIGITIZING PAPER RECEIPTS

(71) Applicants: Kabushiki Kaisha Toshiba, Minato-ku (JP); Toshiba TEC Kabushiki Kaisha, Shinagawa-ku (JP)

(72) Inventors: Christopher NGUYEN, Huntington Beach, CA (US); Jia ZHANG, Irvine, CA (US); William SU, Riverside, CA (US)

(21) Appl. No.: 15/712,507

(22) Filed: Sep. 22, 2017

(51) Int. Cl. G06F 17/24; G06Q 40/00; G06K 9/00; H04N 1/00

(52) U.S. Cl. CPC G06F 17/243; G06Q 40/12; H04N 1/00167; G06K 9/00449; H04N 1/00135; G06K 9/00456

(57) ABSTRACT

A system and method for concurrent scanning of individual documents includes an intelligent controller having a processor and memory and a scanner that generates an electronic image from a group of hard copy receipts disposed on its platen, face down in any orientation such that there is a spacing between them. The platen receives a plurality separated paper receipts on its surface and the controller generates a contiguous area mask corresponding to a perimeter of each of the receipts. The controller then generates a unique image file corresponding to a surface image of each of the receipts in accordance with this mask. Image files for the receipts are placed through optical character recognition and the resulting character data is used to orient each corresponding receipt image. Character information is also used to generate expense reports.

### TECHNICAL FIELD

This application relates generally to digitizing paper receipts. This application is more particularly directed to simultaneously generating separate, aligned receipt image files from a single scan on a multifunction peripheral.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Paper receipts are generated for virtually any commercial transaction. Receipts are essential for securing reimbursement for business expenses or for tax records. However, paper receipts can easily be lost or damaged, such as by exposure to heat or water. A large number of receipts can be also be bulky to transport, such as by stuffing them into a wallet.

### SUMMARY

In accordance with an example embodiment of the subject application, a system and method for concurrent scanning of individual documents includes an intelligent controller having a processor and memory and a scanner that generates an electronic image from hard copy disposed on its platen. The platen receives a plurality separated paper receipts on its surface and the controller generates a contiguous area mask corresponding to a perimeter of each of the receipts. The controller then generates a unique image file corresponding to a surface image of each of the receipts in accordance with this mask.

### BRIEF DESCRIPTION OF THE DRAWINGS

Various embodiments will become better understood with regard to the following description, appended claims and accompanying drawings wherein:

FIG. 1 is an example embodiment of a receipt scanning system;

FIG. 2 is an example embodiment of a networked digital device;

FIG. 3 is an example embodiment of a platen disposed above a scanner bar;

FIG. 4 is an example embodiment of a scan mask;

FIG. 5 is an example embodiment of a composite receipt scan; and

FIG. 6 is a flowchart of an example embodiment of operations for generating a composite receipt scan.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

When paper receipts are accumulated, it is advantageous to scan them into electronic form. Image files for receipts can be archived, such as by saving them to a server. They can also be sent to a network destination, such as by attaching them to an e-mail for electronic delivery. It is possible to sequentially scan each of a plurality of receipts. This may be done by aligning a paper receipt on an MFP platen, closing a device cover, and selecting a scan option on the device. Receipts are often flimsy, and may shift on a platen or even fall off entirely when a cover is lowered for copying. A scan image of a receipt may be placed through an optical recognition (OCR) algorithm to extract character data, such as cost reflected by the receipt. OCR programs may be adversely affected by character information on a scan image that is oriented incorrectly.

Multiple receipts may be copied at once, but this only further exacerbates misalignment problems. Also, receipts come in an expansive number of sizes and shapes. It is extremely problematic to align multiple receipts on a platen for simultaneous copying. And, if this is attempted, a user must further position them as best possible so that all character information is in the same, or extremely close orientation. This is particularly important if an OCR operation is to be performed on an image embodying multiple receipts.

In an example embodiment, a MFP scanner platen may have a size of approximately 12×18 inches. Much of that space may be unusable when multiple receipts are co-aligned. Example embodiments described herein facilitate a user placing multiple receipts on a platen for simultaneous scanning. There is no particular alignment requirement when the user simply places the receipts at a slight distance from the other receipts. Some receipts can be vertical, some can be horizontal, and some may be placed at an angle. Thus, many more receipts can fit on a platen at once for simultaneous scanning. Also, there is no requirement that the user close the scanner cover prior to scanning. While example embodiments herein are directed to scanning of receipts, it will be appreciated that the subject application is applicable to simultaneous scanning of any document inclusive of character data, such as text.

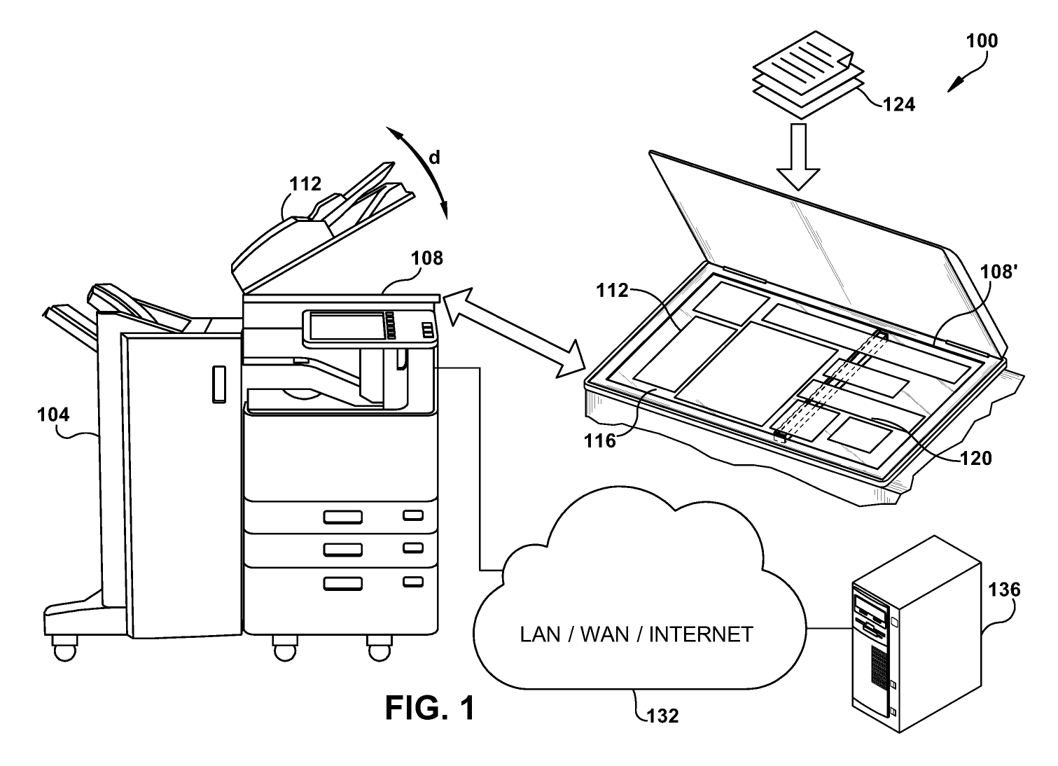

In accordance with the forgoing application, FIG. 1 illustrates an example embodiment of a receipt scanning system 100 that includes MFP 104. MFP 104 includes a scanner configured to scan documents disposed on platen 108. Scanner cover 112, illustrated as part of an automated document feeder (ADF), is moveable relative to platen 108 to cover documents placed on the platen during a scan operation. If a scan is made without a cover, areas not covered by a document are subject to extreme overexposure and will appear black on the resultant scan. Printouts of such scans require large amounts of extraneous toner. In the example embodiment, cover 112 is pivotable relative to platen 108 in a direction “d.” A perspective view of platen 108 is found at 108′. Platen 108′ illustrates placement of individual receipts 112, 116 and 120 from a group of receipts 124. Receipts are suitably placed, image portion down, in any orientation and any relative position on platen 108′. Multiple receipts can be positioned in any way to use as much of a surface of platen 108′ as possible. Each receipt need only be positioned so that there is spacing between it and other receipts in group 124. Details of the resultant scanning operation are detailed further below.

MFP 104 is suitably connected to one or more digital devices by a network 132, suitably comprised of a local area network (LAN) or a wide area network (WAN) which may comprise the Internet, or any suitable combination thereof. Network 132 suitably provides for data communication between MFP 104 and one or more devices, such as server 136.

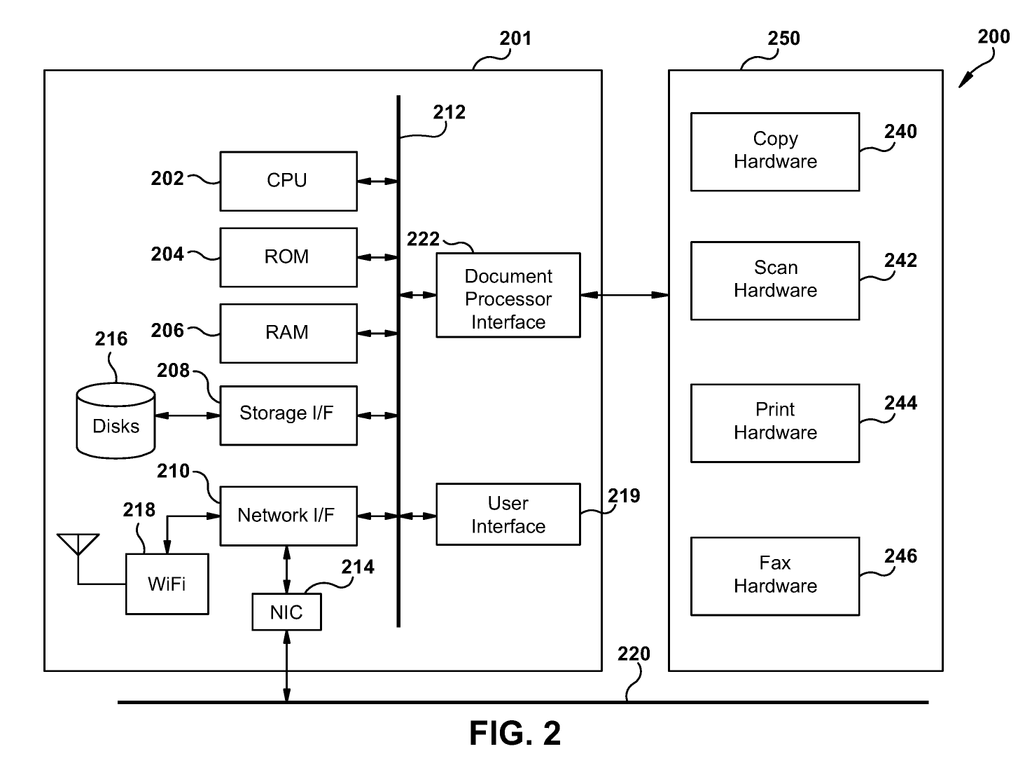

Turning now to FIG. 2 illustrated is an example embodiment of a networked digital device comprised of document rendering system 200 suitably comprised within an MFP, such as with MFP 104 of FIG. 1. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with BLUETOOTH Interface 221 which may be programmed to function as a device beacon as noted above.

Processor 202 can also be in data communication with any suitable user input/output (I/O) interface 219 which provides data communication with user peripherals, such as displays, keyboards, mice, track balls, touch screens, or the like.

Also in data communication with data bus 212 is a document processor interface 222 suitable for data communication with MFP functional units 250. In the illustrated example, these units include copy hardware 240, scan hardware 242, print hardware 244 and fax hardware 246 which together comprise MFP functional hardware 250.

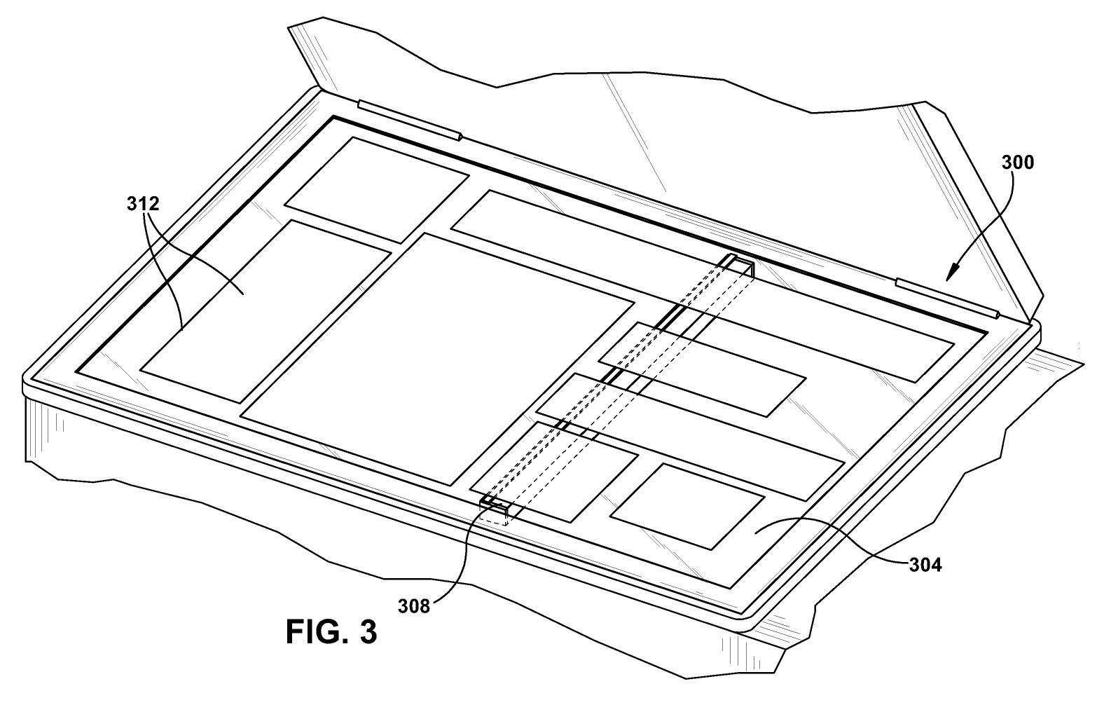

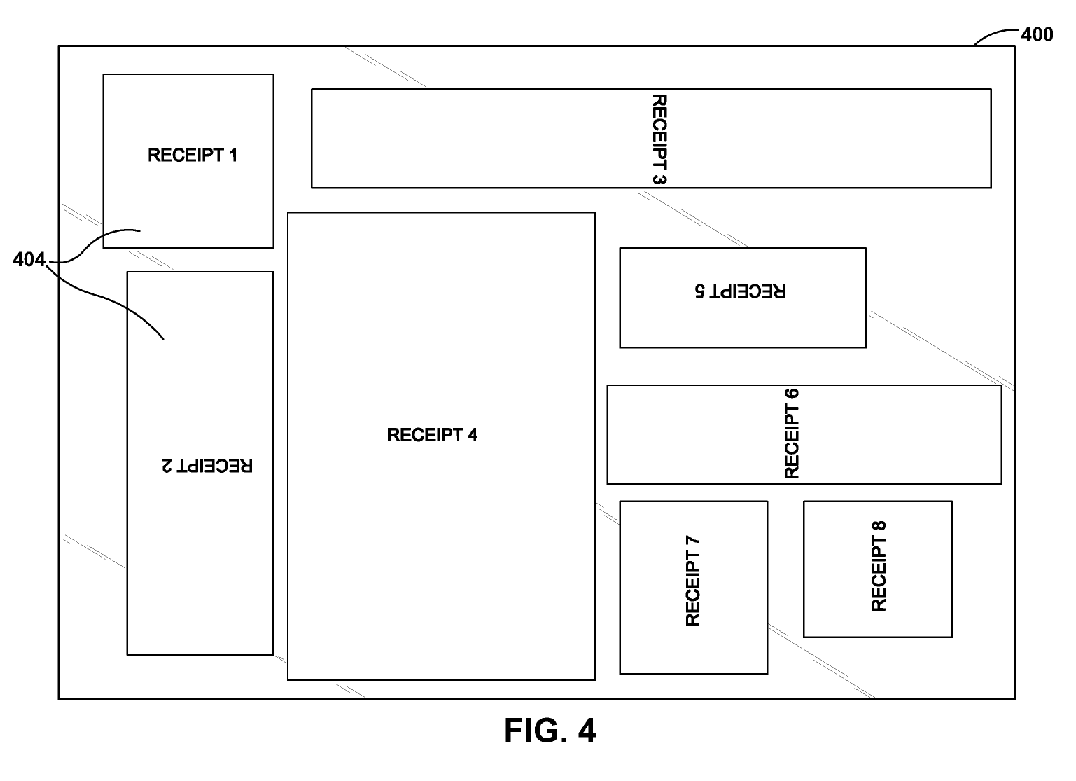

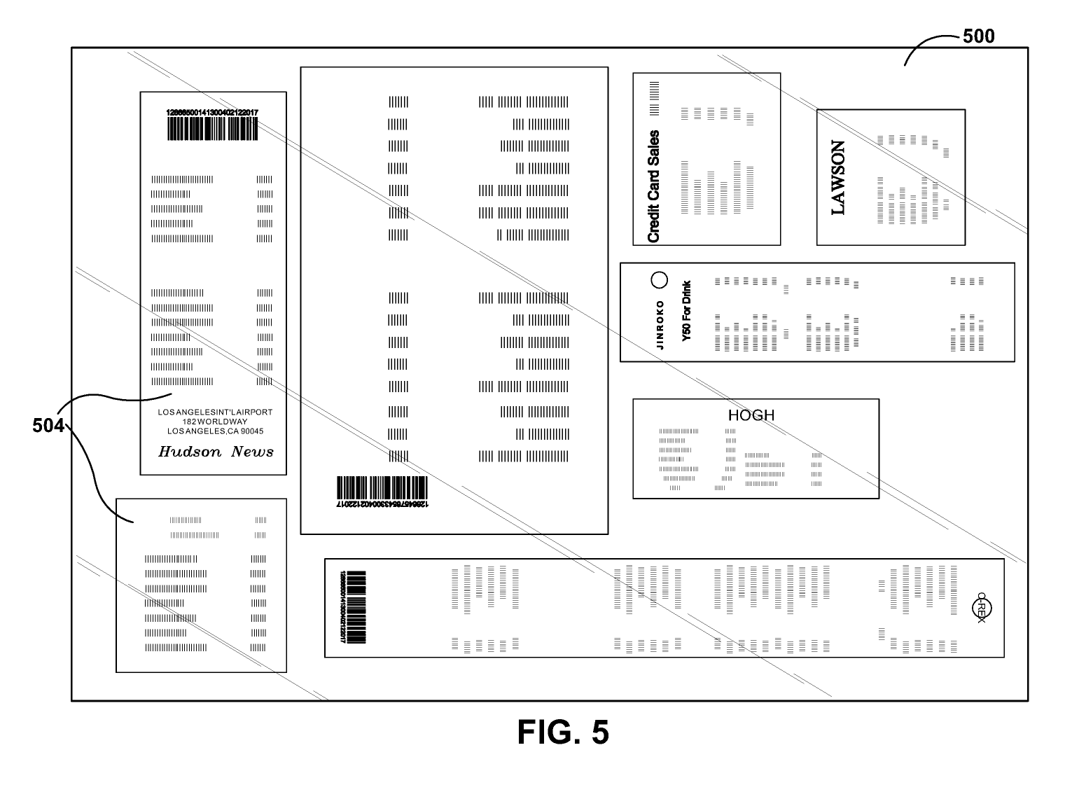

Referring next to FIG. 3, illustrated is a scanner 300 having a platen 304 that is disposed above a scanner bar 308 that traverses the platen 304 during a scan. A plurality of receipts 312 are positioned on a surface of platen 304. It will be noted that platen 304 is uncovered during the illustrated scan. FIG. 4 illustrates a contiguous mask 400 which defines a plurality of areas 404 corresponding to a position of receipts 312 on platen 304 in FIG. 3. FIG. 5 illustrates a composite receipt scan 500 wherein receipt images 504 are isolated in accordance with mask 400 of FIG. 4.

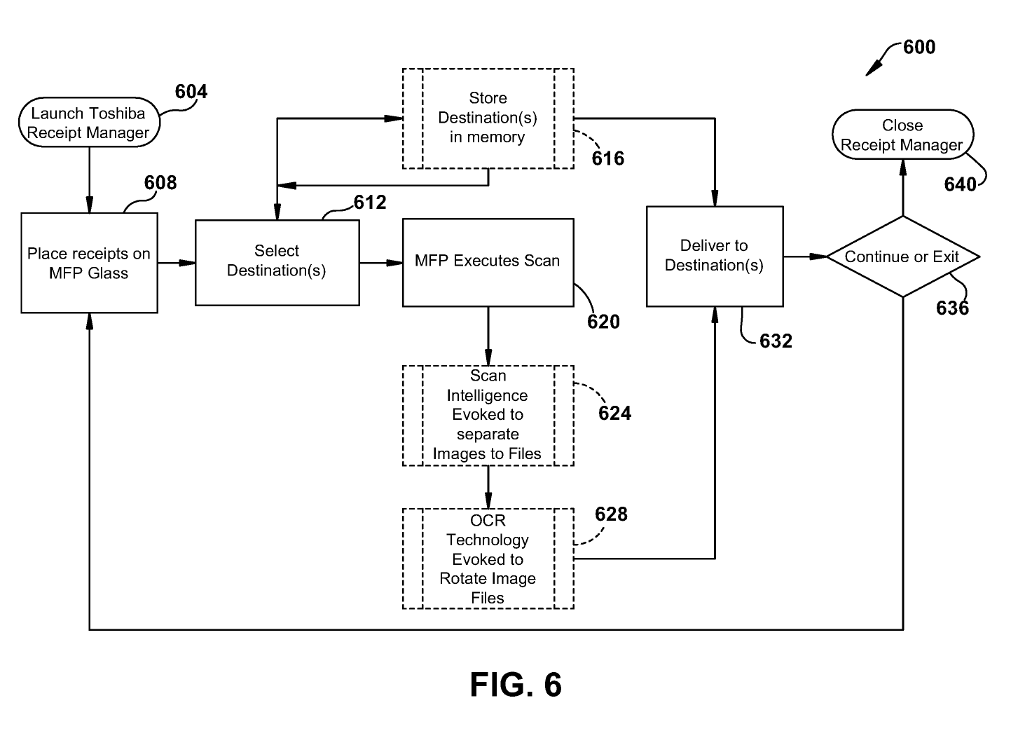

FIG. 6 is a flowchart 600 of an example embodiment of a composite receipt scan system such as that detailed above. The process commences at block 604 and receipts are positioned on a platen glass at block 608, recalling that there is spacing between each receipt. The user suitably selects a destination for sending scan or report data at block 612, and this selection is stored in block 616. The MFP executes a scan at block 620, and a resultant mask is used to separate receipt images into distinct files at block 624 as described above. An OCR operation is performed on receipt images at block 628 to extract character data, and the results are delivered to the previously stored destination at block 632. If additional scans are selected at block 636, the process returns to block 608. If not, the process ends at block 640.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a platen configured to receive a plurality separated paper receipts on a surface thereof;
a moveable cover configured to selectively cover and uncover the platen;
a scanner configured to generate an electronic image from hard copy disposed on the platen; and
an intelligent controller including a processor and memory,
the controller configured to enable the scanner to operate when the platen is in an uncovered position,
the controller further configured to generate a scan mask from the scanner, the scan masked comprised of a contiguous area defining a perimeter of each of the receipts, and
the controller further configured to generate a unique image file corresponding to a surface image of each of the receipts in accordance with a plurality of discrete scan areas defined by the scan mask.

2. The system of claim 1 wherein the controller is further configured to align each surface image of each image file in a selected orientation.

3. The system of claim 2 wherein the controller is further configured to extract character data for each image file.

4. The system of claim 3 wherein the controller is further configured to align each surface image in accordance with extracted character data.

5. The system of claim 4 wherein the controller is further configured to align each surface image in accordance with extracted numeric character data.

6. The system of claim 5 wherein the controller is further configured to generate an expense report file corresponding to extracted numeric character data.

7. The system of claim 6 wherein the controller is further configured to generate an aggregate expense report file corresponding to extracted numeric character data from each of the receipts.

8. A method comprising:
opening a cover to expose a platen of a scanner;
placing a plurality of separated paper receipts on a surface of the platen;
scanning the platen, including a scan of uncovered areas of the platen and each of the paper receipts, into an electronic image when the platen is in an uncovered position;
isolating a contiguous area of the electronic image corresponding to a perimeter of each of the receipts;
generating a scan mask from an isolated contiguous area; and
generating a unique image file corresponding to a surface image of each of the receipts in accordance with the scan mask.

9. The method of claim 8 further comprising aligning each surface image of each image file in a selected orientation.

10. The method of claim 9 further comprising extracting character data for each image file.

11. The method of claim 10 further comprising aligning each surface image in accordance with extracted character data.

12. The method of claim 11 further comprising aligning each surface image in accordance with extracted numeric character data.

13. The method of claim 12 further comprising generating an expense report file corresponding to extracted numeric character data.

14. The method of claim 13 further comprising generating an aggregate expense report file corresponding to extracted numeric character data from each of the receipts.

15. A system comprising:
a scanner including a platen configured to receive multiple, separated paper receipts on an uncovered surface thereof,
the scanner configured to scan the paper receipts through the platen to generate a composite scan image; and
a processor configured to determine an overexposed area of the scan image corresponding to a platen area not covered by the receipts,
the processor further configured to generate a contiguous mask image in accordance with the overexposed area, and
the processor further configured to generate a separate image file for each of the receipts in accordance with the mask image.

16. The system of claim 15 wherein the processor further configured to extract numeric character data from each separate image file.

17. The system of claim 16 wherein the processor is further configured to generate an aligned image file for each of the separate image files in accordance with extracted numeric character data.

18. The system of claim 17 wherein the processor is further configured to generate an expense report file corresponding to extracted numeric character data in each separate image file.

19. The system of claim 18 wherein the processor is further configured to generate an aggregate expense report in accordance with extracted numeric character data from all of the separate image files.

20. The system of claim 19 wherein the processor is further configured to send the separate image files and the expense report files to a networked device via a network interface.
